(19) United States
(12) Patent Application Publication
(10) Pub. No.: US 2002/0099725 A1
(43) Pub. Date: Jul. 25, 2002

(54) Automation of construction and decoration projects

(76) Inventor: Thomas A. Gordon, South Glastonbury, CT (US)

Correspondence Address: McCormick, Paulding & Huber, City Place II, 185 Asylum Street, Hartford, CT, 06103-3402, US

(21) Appl. No.: 10/034,948

(22) Filed: Dec. 28, 2001

Related U.S. Application Data
(60) Provisional application No. 60/259,491, filed on Jan. 3, 2001.

(51) Int. Cl. G06F 17/60

(52) U.S. Cl. 707/200; 705/14; 705/27

(57) ABSTRACT

A system for managing a development project for a customer includes at least one database having data, and allows the customer to select at least one selected product from at least one of the databases, and provides for viewing at least one selected product. The system allows customer to manage a project through a website and determine how various changes to the project will affect cost, time and other variables. The system can also allow customer to collaborate on a development project with installers, architects and other workers. The system allows customer to match a product to particular requirements. A kiosk system allows customer to view various products within the store, make selections through the kiosk and, potentially, match product to a particular requirement.

This application claims priority and benefit of Provisional Application Serial No. 60/259,491 filed Jan. 3, 2001 which is incorporated by reference herein.

### BACKGROUND OF THE INVENTION

1. Technical Field

This invention relates to automation of construction and decoration projects and, more particularly, to improvement therefor.

2. Background Art

The advent of worldwide web or internet has revolutionized and automated many aspects of our lives. For example, orders for stocks can be placed over the internet, clothing and wares can be purchased without leaving home, and wealth of information and news can be instantaneously downloaded to one's computer. However, some aspects of everyday life have remained painfully time-consuming and logistically frustrating. For example, selection of wallpaper, paint, flooring and/or appliances for either a new construction or a redecoration project is a long and highly labor-intensive process. To date, there are a number of unresolved problems and drawbacks to the process.

During a construction or a structural remodeling phase, coordinating between the architect, homeowner, contractor, subcontractors, painters, and interior decorators is a hassle, at best. It takes weeks and months to determine cost and schedule of a project. The problem becomes exacerbated if and when the customer wants to make a change. Informing everyone involved that a change has taken place can be a daunting task. However, getting feedback from contractor and subcontractors regarding cost and scheduling changes as a result of the change in the plans can seem an absolutely impossible undertaking. Furthermore, even cost estimates received from contractors may not include material price changes for items, such as flooring, paint, wallpaper and so forth. Currently, the effort requires multiple phone calls and faxes among all the involved parties.

Selection of finishing materials, and more importantly, coordination thereof can take what seems an eternity and often does not yield the desired results. For example, selecting paint colors still requires a trip to a store and a small, if any, sample of color. That does not always reflect how the room will look when a much larger surface area, such as a wall, will be painted. Furthermore, once a selection of paint is made, the small sample will have to be taken to a flooring supply store, tile store, appliance store, to ensure that all colors are matched and properly coordinated. Coordinating color of a new or existing appliance is especially difficult since color swatches for appliances do not exist and the appliance itself is not generally portable.

One of the worst experiences one will probably encounter is selecting wallpaper. Typically, a store will have dozens of books with samples (pages) of different wallpaper secured therein. Customers will have to go through each book to determine what type and general style of paper they like. Once the customer narrows down to a certain number of books, she/he will have to go through each book to select several choices of wallpaper. One problem that arises is that many stores loan these books to customers. Thus, the store could be missing quite a number of books at any one time, precluding other customers from seeing all the books. Another problem is that some customers cut out samples of paper they want, eliminating these samples from being further selected by others. However, even if the book is available, it is difficult to predict and visualize how the paper will look on the wall with particular lighting. The sample books themselves are quite heavy and difficult to transport. They are clumsy and impossible to view in place at more than arms length.

From the standpoint of a store owner, the store must first purchase these dozens of wallpaper books, each of which can be very costly, maintain these books in somewhat of an order within the store, and provide valuable and often expensive floor space for storing these books. Additionally, the store must frequently replace the books if pages have been damaged or entirely ripped out. Furthermore, the store owner must track which books have been loaned and, at least, attempt to secure timely return of the loaned books.

From the standpoint of a wallpaper manufacturer, the sample books represent a significant investment. Patterns that prove to be unpopular, still must be inventoried and have the same cost structure as the most popular styles. Many of the most popular designs do not receive sufficient exposure since it is likely that the most popular selections are ripped out with the most frequency or are more often taken home by a customer. Also, the manufacturer does not obtain accurate feedback regarding what models are most popular since it is not known how long ago these models of the wallpaper have been missing from the book.

Another drawback to the existing process is that even if the owner chooses to undertake repainting, expansion or any other construction or redecoration project that requires matching of the existing colors to new colors in a number of years after the initial project, no one usually remembers or has samples of the existing colors. Therefore, matching the older versions of selections becomes nearly impossible.

Therefore, it would be desirable to improve and simplify the process of coordinating a construction project and/or a redecoration project.

### SUMMARY

According to one embodiment of the present invention, a system for managing a development project for a customer includes at least one database having data, means for allowing the customer to select at least one selected product from at least one of the databases, and means for viewing said at least one selected product. The system allows customer to manage a project through a website and determine how various changes to the project will affect cost, time and other variables.

According to another embodiment of the present invention, a system for collaborating on a development project for a customer includes means for generating a personal file for the customer, means for providing repeated access to the customer, means for allowing the customer to allow access to other users, at least one database having data, and at least one interactive module allowing the customer to interact with at least one of the databases to make product selections and to allow the customer access to schedule of the other users. The system allows customer to collaborate on a development project with installers, architects and other workers.

According to a further embodiment of the present invention, a system for generating large scale graphics includes at least one database having data regarding various products, means for selecting at least one product from at least one of the databases, and a printing unit for printing the product as a large scale graphic on self adhesive sheet material for subsequent application. The system allows printing of proofs as well as replacement pieces of wallpaper and other wallcoverings that do not require large quantities, such as borders and trim.

According to a further embodiment of the present invention, a kiosk system for selecting a product in a store includes means for generating a personal file for a customer, at least one database having data regarding to various products, means for allowing to select at least one selected product from at least one of the databases, and means for viewing at least one selected product. The system allows customer to view various products within the store, make selections through the kiosk and, potentially, match product to a particular requirement.

According to a further embodiment of the present invention, a system for matching at least one product includes at least one database having data regarding various products, means for allowing the customer to match and select at least one matched product from at least one of the databases to match a particular color, and means for printing at least one matched graphic. The system allows customer to match a product to particular requirements.

The foregoing and other advantages of the present invention become more apparent in light of the following detailed description of the exemplary embodiments thereof, as illustrated in the accompanying drawings.

### BRIEF DESCRIPTION OF THE DRAWINGS

FIG. 1 is a schematic diagram of a system for managing a development project for a customer, according to the present invention;

FIG. 2 is a schematic view of a sheet material generated through use of the system of FIG. 1 to be placed onto a wall;

FIG. 3 is a schematic view of a decorator's module utilizing the system of FIG. 1; and

FIG. 4 is a flow chart diagram of a method for coordinating and managing a development project for a customer using the system of FIG. 1.

### DETAILED DESCRIPTION OF THE INVENTION

A system 10 for managing a development project includes a dedicated website 12 accessible via world wide web or internet. The website 12 includes a plurality of personal files 14, one for each customer for a project. Each personal file 14 is set up for the purpose of including project data and/or information. The customer has a customer identification password or number. The system 10 also includes at least one database 16. The databases include data and lists, including samples, of wallpaper, paint colors, appliance style and colors, floor coverings, draperies, blinds and accessories as well as construction variables such as: windows, doors, trim, lumber variety, lighting fixtures and many other elements. The databases 16 may also include cost and delivery information regarding each item.

The system 10 also includes one or more application modules 20 for performing various functions, applications and/or operations. One such application has capabilities for providing immediate cost estimates once selection is made and dimensions are either input or obtained from the existing file. A further application includes scheduling estimates for the project and in the event of a construction design change once work has commenced. Another application includes a heuristic suggestion algorithm that is continually refined based on the responses of the users. A further application is a coordination algorithm that keeps track of selections that were already made. Additional applications can be also implemented to aid the process of managing and coordinating a project.

The system 10 may further include at least one interactive module 22 that allows the master customer to fill out a profile, on-line, regarding demographic information, financial constraints, and other personnel preferences, such as overall style preference, color preference and others. Based on the input information, the interactive module provides a list of suitable choices, selections or suggestions. The interactive module 22 may also include scheduling information regarding each of the contractors, such as access to the contractors' individual calendars.

The system 10 may also include at least one archive module 24 that stores previous data regarding the customer, project or other information. Thus, if the master customer had previously purchased paint, wallpaper, appliances or has made any other choices, these previous selections are factored into a suggestion list that is subsequently presented to the customer. The customer could then narrow down the selection to several choices.

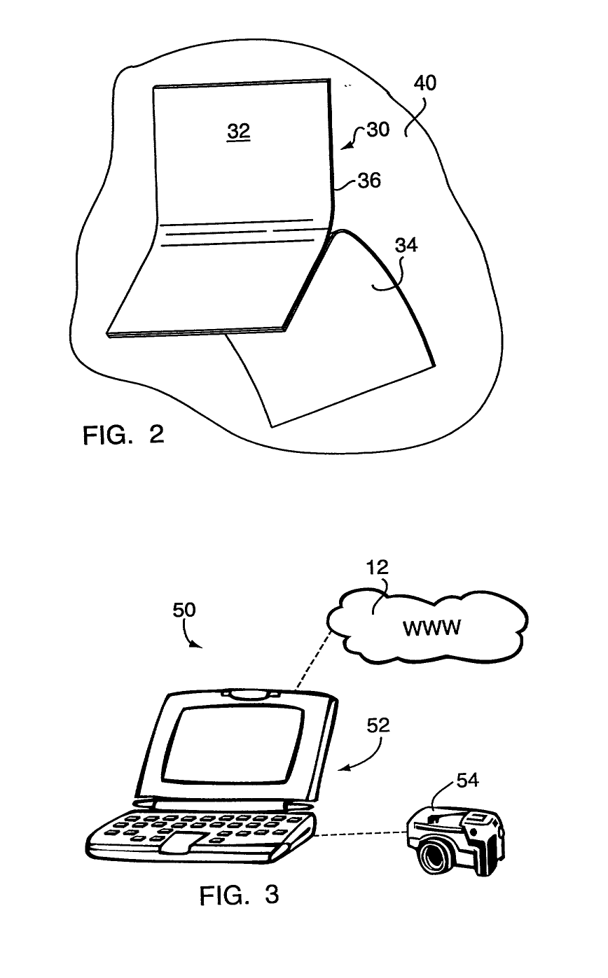

The system 10 also includes a printer unit 26 that has a printer with sheet or roll material 30. The material 30 includes a top printable layer or substrate 32, and possibly, a removable backing sheet 34 with an adhesive layer 36 sandwiched therebetween, as shown in FIG. 2. Alternatively, a light tack adhesive can be used, either pre-applied to the substrate or applied to the back of the material at the time of printing. The printing unit 26 has the capability of carefully matching color to the actual wallpaper manufacturer's design. The printing unit also has capability of simulating texture or at least printing on a variety of textured materials. Once the customer has made at least one selection, he/she would print out the selected sample on the printer unit 26. The sample can be printed in a large form on the sheet or roll material. Once the printer completes printing one or more samples, the customer can bring those samples home and, if desired, adhere the sample wallpaper or large scale paint color swatch onto a wall 40.

The customer does not need to save the samples for future reference, since this system has the capability of archiving the selection for future reference.

The system may also include a plurality of help modules 42 and complimentary product modules 44. Once a customer has made a selection of a certain product, such as wallpaper, the help module 42 will post a checklist of required tools and accessories needed for the customer to complete the project on his own. The complimentary product module 44 will provide a list of contractors and/or wallpaper professionals for the demographic area of the customer and other complimentary lists. Since the system 1o understands the exact dimensions of the specific job, cost estimating for the installation labor can be performed remotely at this time. The job can even be scheduled remotely as the system ties in with the calendars of all the listed installers.

The customer also has an option of providing various forms of access to other users. For example, there may be authorized and/or privileged users, each type having varying degrees of access. Privileged users have the ability to access the data and introduce changes thereto. Authorized users will be able to obtain information and data without the ability to make changes.

According to a feature of the present invention, a decorator's module 50 is available for interior decorators and design consultants. The decorator's module 50 includes a laptop computer 52 and a digital camera 54, as shown in FIG. 3. Each room of a customer's house can be photographed with the digital camera 54. The digitized image can be viewed on the laptop 52. Once the decorator suggests or a customer makes selection of paint, wallpaper, trim color, wall coverings, curtains and other accessories, these selections can be displayed in the digitized room. The selections can be colored over the customer's room and coordinated therein. The decorator's module 50 would be connected to the dedicated website via the internet connection or incorporate the system 10 either entirely or partially. The customer will have an opportunity to view on the computer the selection that he or she has made and how it would look in the room. The resulting sample room view can also be printed for future reference.

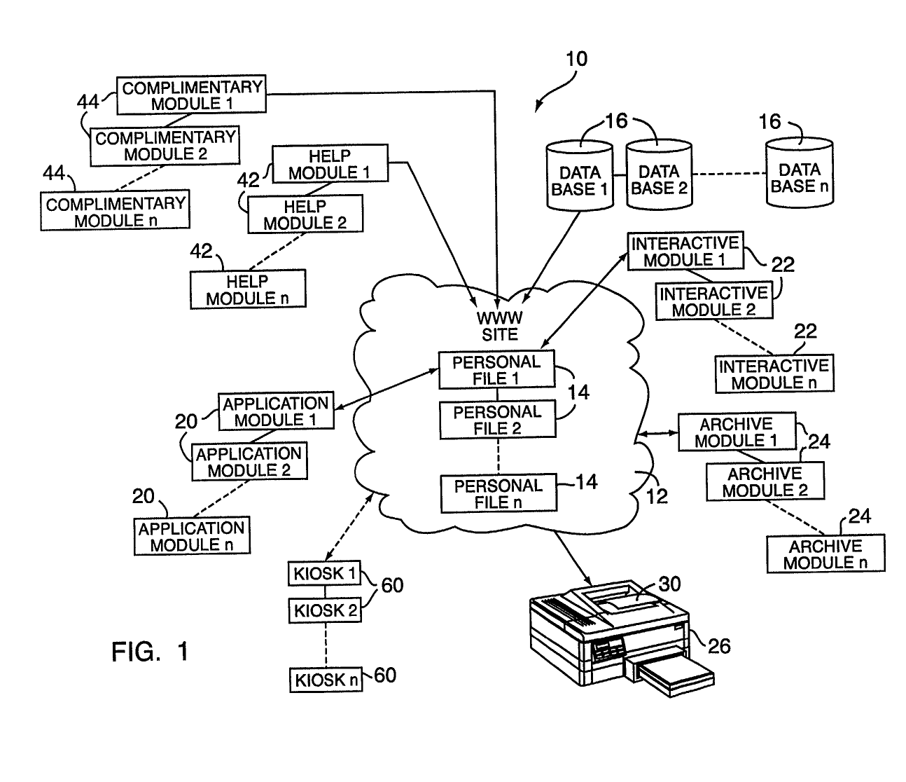

According to another embodiment of the present invention, the access to the site could be available through a store kiosk 60, as best seen in FIG. 1. The kiosk, or a stand-alone computer, that communicates with the website can be placed in a store for the customers to have access to their data while they are actually shopping. An independent kiosk can be used in a store setting. The independent kiosk would contain and include interior decorating products and tips in the database of each manufacturer. The kiosk could also incorporate the system described herein either partially or entirely. The kiosks could be also used to display various advertisements or information during idle time tied in with the specific products of interest or general advertising for local or national advertising campaigns.

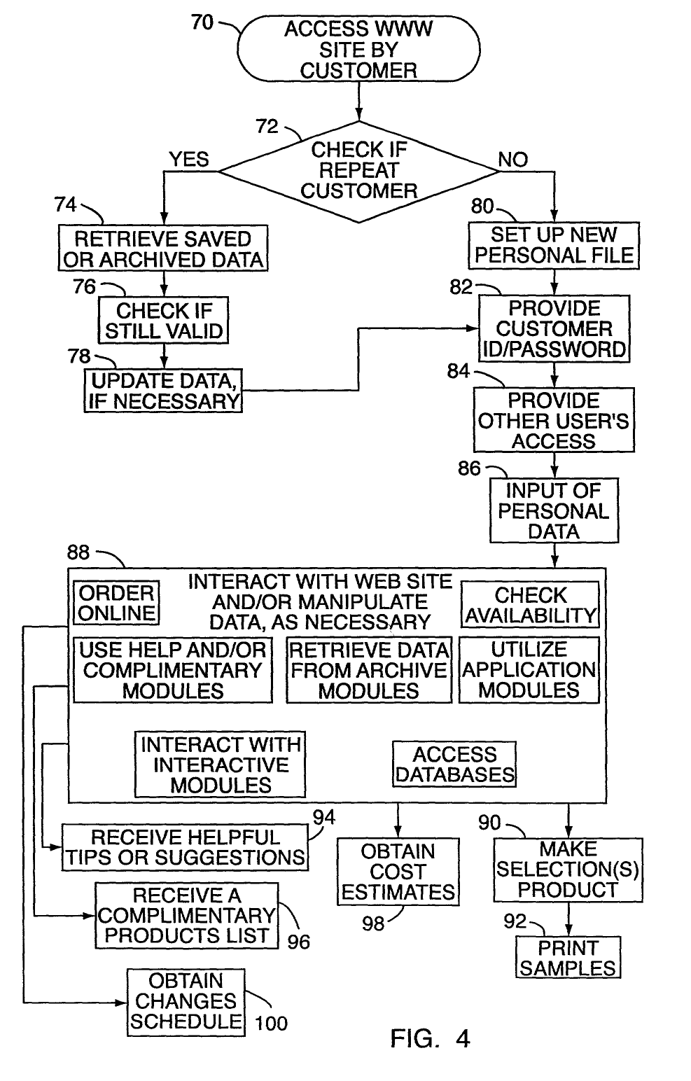

In operation, a customer accesses world wide web site 12, as shown in FIGS. 1 and 4, and indicated by numeral 70 in FIG. 4. Subsequent to customer accessing the site 12, the system 10 would check through its archived files and modules 24 whether the customer is a repeat customer, as indicated by numeral 72 in FIG. 4. If the customer is a repeat customer, then the system 10 would retrieve archived data regarding the customer, as indicated by 74. Subsequently, the system would prompt the customer to verify that the archived information is still valid, as indicated by 76. If the customer indicates that the archived information is no longer valid, the system will prompt the customer to update the necessary information, as indicated by 78. Such information can be used for subsequent target marketing.

If the customer is a new customer, a new customer file 14 is created on the website, as indicated by 80. The file is accessible from anywhere through a connection to the world wide web. A customer password is generated for the customer, as shown by 82. The customer password allows the customer to repeatedly access his/her personal file. The customer password also allows the customer to grant access to other types of users, such as privileged and/or authorized users, as indicated by 84. The privileged users have the ability to repeatedly access the file and also modify the data. For example, a privileged user may be an architect whose input would include a set of architectural drawings. The architect, as a privileged user, will have the capability to change the drawings and/or introduce other information to the personal file.

Either customer or privileged user will input information and data regarding exact dimensions and parameters of any project, including construction of a house or other structure, as indicated by 86. The exact dimensions of every room can be input for subsequent calculation of material and labor required to finish that room or any other particular space. The dimensions will enable the software to provide material and labor cost information in broken down format, such as costs of lumber, paint or wallpaper and cost of labor therefor.

An authorized user, such as a contractor, who will be responsible for building the project to the architectural plans, will have limited access. The authorized user may be able to post notes and progress reports as well as estimates for the customer to access. The authorized user would also be able to obtain the necessary information from the website, without capability of changing or modifying the data in the file. Other authorized users, such as flooring, painting and decorating professionals, may be given limited access to the personal file to obtain information and data therefrom.

In the event that a customer or architect introduces a change to the initial plans, the system 10 would provide them with feedback regarding changes in the schedule, and labor and material costs as a result of the change to the original plans. The system would access the databases 16 to obtain cost of the material, use one of the application modules 20 to do calculations, and gather information from the personal file 14 regarding the size of the room to recalculate the cost of the change. Databases 16 are maintained current providing a direct link back to product manufacturers. The customer would have ability of substituting various minor materials such as wallpaper or paint into the program or major alterations such as wall locations, addition of windows, altering cabinet locations with the system providing cost and schedule estimates for various choices the customer would make.

Thus, once the customer has input all the information and/or updated the existing information, the customer will have an opportunity to interact with the web site 12 and manipulate data in numerous ways, as indicated by 88. One goal of the present invention is to provide an improved method for a customer to select products such as wallpaper, paint colors, draperies and accessories, blinds, appliances and other items necessary to complete a decoration or construction project, as indicated by go. Therefore, customer could access one of the systems databases 16 that includes samples of the necessary product. For example, if customer needs to select wallpaper, the system 10, using its heuristic algorithm and the interactive module 22, would prompt the customer to answer a number of questions, therefore, limiting and focusing selection of wallpapers that the system 10 would present to the customer. Once a certain selection is presented to the customer, the customer could select several choices from the given sample list.

Once the choices are made, the customer could print one or more samples on the printer, as indicated by 92. The printer has capabilities of matching color and texture of the chosen wallpaper or other products. The sample is printed on a generous piece of material that can be brought home. The high quality printer can be located in a store or a central location. The customer can print a sample in a store and bring the sample home. Alternatively, the customer can request the sample to be printed for him/her either at the store or central location (such as a website administrator) and then mailed to the customer. Once at home, the paint or wallpaper sample can be applied to the wall, or printed carpet, tile, vinyl, laminate, or simulated wood sample could be applied to the floor for evaluation in a home setting, as shown in FIG. 2. The generous self-adhesive sample would allow the customer to make a better decision regarding his/her selection under real conditions. If a customer does have a printer, the samples can be printed by the customer at home.

Additionally, based on what particular product the customer is interested in, the help module 42 could provide the customer with a list of decorating tips or helpful suggestions, as indicated by 94. Also, the complimentary products module 44, based on customer selection, could provide the customer with complimentary products and a checklist of required tools and accessories or names of contractors that are skilled to install the chosen products, as indicated by 96.

Furthermore, as discussed above, the customer can obtain cost estimates and change in schedules, as indicated by 98, 100.

The kiosk option could be placed in any wallpaper or paint or other types of store and be connected to the website 12. If the kiosk 60 is connected to the website 12, the customer could access his/her personal data through the kiosk 60 and the website 12. For example, if the customer is in a store and does not remember exact dimensions, the customer could access the website 12 to obtain the dimensions and other necessary information through the kiosk. However, the kiosk 60 could be a stand-alone unit that includes databases with certain products and incorporates most or all features located on the website 12. The kiosk 60 located in various stores could also include advertisements during idle time. For example, if the kiosk is not being used by the customer, the retailer may choose to run certain advertisements thereon.

The system of the present invention has many benefits to customers, contractors, and product manufacturers. The main benefit of the system to the customer is that it improves and streamlines selection process of products for a construction or redecoration project. The system eliminates the need of going back and forth between various stores and home and allows for easy color/style matching. The system also eliminates the need for bringing bulky wallpaper books home. The customers could also place orders from home without the need of making multiple trips to the store. Additionally, the customer has reasonable sized samples that can be either retained or thrown away. Some graphics, such as wall borders can be printed and retained. Additionally, if a portion of wallpaper has been damaged, customer may print the needed amount of wallpaper to replace the damaged portion. The sample size and ability of the sample to be secured to the wall allows customers to get a better idea of how the final product would look in his/her environment. Furthermore, the selection profile would remain with the website for future purchases. The system could also serve as a fine art proofer for samples and actual fine art reproductions or gicl'ees.

The benefits to the retailer are also great. First, it eliminates the need for keeping wallpaper books in the store and multiple samples of other products. Elimination of maintaining wallpaper books in the store and multiple samples of other products allows the retailer to free up valuable floor space in the store. Furthermore, elimination of wallpaper books and multiple samples saves significant amount of money for the manufacturer, distributor, and retailer. The system 10 also eliminates the need to keep the wallpaper book library current, the need to track books that have been loaned, and the need to replace the books that have not been returned. Furthermore, the system of the present invention offers the retailer a unique opportunity for marketing. The shop name can be printed on each of the proof samples, therefore, keeping the shop name and phone number in front of the customer. Second, the shop can supply through its help and complimentary modules 42, 44 offers and suggestions regarding its other products and/or affiliated installers. The retailer also has access to database of customer profiles, thereby enabling the retailer to cater to specific customer needs. This affords the retailer with a target marketing opportunity only available up to now over the Internet. The Internet excels in target marketing where an offer is made to a specific customer based on his browsing trail interest. Now, for the first time, a retailer has the same target marketing opportunity. Promotions at retail can now be designed and tailored to a single person—“That wallpaper is nice, but this similar design by another manufacturer is better quality at a lower price . . . The paint that matches that wallpaper is on sale if you order it at the same time . . . If you carpet only one additional room, installation will be free, today only . . . The matching wallpaper border is 50% off with the order . . . Customers like you have decorated like this” to name just a few.

The benefits to manufacturers of products are also many. For example, for manufacturers of wallpaper products, the need to produce and maintain many of the sample books is eliminated. With sample selection being accessed through the web, the manufacturers do not have to concern themselves with certain wallpaper samples being missing from the book and, therefore, not getting the proper exposure. The wallpaper manufacturers can also obtain real time, critical point of purchase data on which products are most successful never before available to them.

While the present invention has been illustrated and described with respect to a particular embodiment thereof, it should be appreciated by those of ordinary skill in the art, that various modifications to this invention may be made without departing from the spirit and scope of the present invention. For example, although for clarity references are made to archive modules, help modules, complimentary modules, interactive modules, and application modules, these functions do not need to be segregated and can be operating jointly. It is within the scope of the present invention that equivalent functionality can be implemented using a variety of software and firmware techniques that are known to one of ordinary skill in the art. Additionally, various combinations of various features described herein can be combined into a system.

What is claimed is:

1. A system for managing a development project, said system comprising:
means for generating a personal file for a customer;
at least one database having data;
means for allowing said customer to select at least one selected feature from at least one of said database; and
means for viewing said at least one selected graphic.

2. The system according to claim 1 further comprising:
means for providing repeated access for said customer.

3. The system according to claim 1 further comprising:
means for allowing said customer to allow access to other types of users.

4. The system according to claim 1 wherein said customer can access schedule of other users.

5. The system according to claim 1 wherein said means for viewing is a printing unit allowing said customer to print at least one selected graphic thereon.

6. The system according to claim 5 wherein said printing unit prints proofs based on customer selection.

7. The system according to claim 6 wherein said proofs are samples of wallcovering.

8. The system according to claim 6 wherein said proofs are wallcoverings such as trim or border to be retained as such.

9. The system according to claim 6 wherein said proofs are samples of wallcovering such as trim or border to be used a sample.

10. The system according to claim 6 wherein said proofs are printed on a large sheet material for customer to apply to a final location.

11. The system according to claim 6 wherein said proofs are printed on self-adhesive material to be applied to a final location.

12. The system according to claim 6 wherein said printing unit prints an indicia including information regarding said proof for future reference and reorder.

13. The system according to claim 5 wherein said printing unit prints a final product with simulated texture.

14. The system according to claim 5 wherein said printing unit prints a metallic foil product.

15. The system according to claim 1 wherein said means for viewing is a monitor unit allowing said customer to view at least one selected graphic thereon.

16. The system according to claim 1 wherein said means for viewing is a printing unit for printing said selected graphic on material with adhesive properties.

17. The system according to claim 1 wherein said means for viewing is a printing unit for printing said selected graphic for permanent application on material with adhesive properties.

18. The system according to claim 1 further comprising:
at least one application module allowing said customer to manipulate said data.

19. The system according to claim 18 wherein said application module allows calculation of total cost for a project, including cost for material and labor therefor.

20. The system according to claim 18 wherein said application module provides automatic scheduling adjustment in response to a change in said project.

21. The system according to claim 18 wherein said application module provides automatic cost adjustment in response to a change in said project.

22. The system according to claim 18 wherein said application module provides a heuristic suggestion algorithm for providing refined suggestions to said customer.

23. The system according to claim 18 wherein said application module provides a coordination algorithm for tracking selections made by said customer.

24. The system according to claim 1 further comprising:
means for coordinating schedule of said customer with availability date of materials and schedule of an installer.

25. The system according to claim 1 further comprising:
at least one interaction module allowing said customer to manipulate said data.

26. The system according to claim 25 wherein said interactive module prompts said customer for relevant information and based on provided information outputs suitable choices for said customer.

27. The system according to claim 1 further comprising:
means for generating instructions for installing a product selected by said customer.

28. The system according to claim 1 further comprising:
means for generating instructions for tool and accessory requirement for a product selected by said customer.

29. The system according to claim 1 further comprising:
means for generating delivery instructions for ia product selected by said customer.

30. The system according to claim 1 further comprising:
at least one help module for providing helpful suggestions to said customer based on customer selections.

31. The system according to claim 1 further comprising:
at least one help module for providing a help list to said customer based on customer selections.

32. The system according to claim 1 further comprising:
a decorator module for providing access to a decorator and enabling said decorator to use said system at a customer location.

33. The system according to claim 32 wherein said decorator module comprises:
a digital camera for capturing an image of said customer location; and
a computer for displaying said image and manipulating said image.

34. The system according to claim 33 wherein said customer will be able to preview selections on a computer in its future environment.

35. The system according to claim 1 wherein said database includes a plurality of product choices.

36. The system according to claim 1 wherein said database includes a plurality of paint choices.

37. The system according to claim 1 wherein said database allows custom mixing of colors.

38. The system according to claim 1 wherein said database allows custom matching of colors of various products.

39. The system according to claim 1 wherein said database allows color matching to existing paint.

40. The system according to claim 1 wherein said database allows color matching to selected wallcovering not yet installed.

41. The system according to claim 1 wherein said database includes a plurality of wallcovering choices.

42. The system according to claim 1 wherein said database comprises various construction elements.

43. The system according to claim 1 wherein said database includes times for completion of various construction tasks.

44. The system according to claim 1 further comprising:
means for coordinating and evaluating color matching of various products, including wall covering, floor covering, paint, appliances and window treatments.

45. The system according to claim 1 further comprising:
means for digitally matching color of various products after passing of time.

46. The system according to claim 1 wherein said system has capability of running advertisements.

47. The system according to claim 46 wherein said advertisements are based on customer viewing behavior.

48. The system according to claim 1 further comprising:
means for capturing customer preferences during customer previewing of a product.

49. The system according to claim 1 further comprising:
means for capturing customer purchases for record keeping and subsequent reordering.

50. The system according to claim 1 further comprising:
a kiosk located remotely in a retail store and having access to said system for said customer to access said personal file.

51. The system according to claim 50 wherein said kiosk has capability of running advertisements during idle time.

52. The system according to claim 51 wherein said advertisements are based on customer viewing behavior.

53. The system according to claim 1 wherein said system can be accessed through a world wide web.

54. A system for generating large scale graphics, said system comprising:
at least one database having data regarding various products;
means for selecting at least one product from at least one of said databases; and
a printing unit for printing said product as a large scale graphic on self adhesive sheet material for subsequent application.

55. The system according to claim 54 wherein said large scale graphic is a wallpaper product.

56. The system according to claim 1 wherein said wallpaper product is a wallpaper border.

57. A kiosk system for selecting a product in a store, said kiosk system comprising:
means for generating a personal file for a customer;
at least one database having data regarding various products;
means for allowing to select at least one selected product from at least one of said database; and
means for viewing said at least one selected product.

58. The kiosk system according to claim 57 wherein said kiosk system has capability of running advertisements during idle time.

59. The kiosk system according to claim 57 further comprising:
means for matching said at least one selected product to other products.

60. A system for collaborating on a development project for a customer, said system comprising:
means for generating a personal file for said customer;
means for providing repeated access for said customer;
means for allowing said customer to allow access to other users;
at least one database having data; and
at least one interactive module allowing said customer to interact with at least one of said database to make product selections and to allow said customer access to schedule of said other users.

61. A system for matching at least one product, said system comprising:
at least one database having data regarding various products;
means for allowing said customer to match and select at least one matched product from at least one of said database to match a particular color; and
means for printing said at least one matched graphic.

62. A method for selecting a wallpaper product, said method comprising the steps of:
prompting a customer to input customer password;
determining whether the customer has been previously registered;
retrieving previously input customer preferences, if available;
checking with the customer whether the previously input customer preferences still valid;
prompting the customer for a plurality of personal preferences;
providing a plurality of samples to the customer in response to the input personal preferences; and
allowing the customer to choose one or more samples from the provided plurality of samples.

63. The method of claim 19 further comprising a subsequent step of:
printing each of chosen samples on a printer unit.

64. A method for selecting a wallpaper product through an in-store kiosk, the method comprising the steps of:
providing a terminal in a store;
allowing access to a customer in response to input customer identification password;
determining whether the customer has been previously registered;
retrieving previously input customer preferences, if available;
checking with the customer whether the previously input customer preferences still valid;
prompting the customer for a plurality of personal preferences in response to a plurality of prompts;
providing a plurality of selected samples in response to customer personal preferences;
allowing the customer to select one or more samples from the plurality of selected samples; and
running advertisements on said terminal when said terminal is not in use.

65. A method for coordinating and managing a development project for a customer, said method comprising the steps of:
generating a personal file on a website for said customer;
allowing input of personal information regarding said project into the personal file;
providing access to said personal information to authorized users;
providing privileged access to privileged users; and
providing means for manipulating said personal information to said customer and said privileged users.

66. The method for coordinating and managing a development project according to claim 65 further comprising intermediate steps of:
verifying whether said customer previously registered;
retrieving previously stored data regarding said customer; and
verifying with said customer whether said previously stored data remains valid.

67. The method for coordinating and managing a development project according to claim 65 further comprising an intermediate step of:
providing means for calculating cost, labor and material for said project.

68. A method for selecting a product, said method comprising the steps of:
prompting a customer to input customer password;
determining whether the customer has been previously registered;
retrieving previously input customer preferences, if available;
checking with the customer whether the previously input customer preferences still valid;
prompting the customer for a plurality of personal preferences;
providing a plurality of samples to the customer in response to the input personal preferences; and
allowing the customer to choose one or more samples from the provided plurality of samples.
